(19) United States
(12) Patent Application Publication
(10) Pub. No.: US 2017/0219734 A1
(43) Pub. Date: Aug. 3, 2017

(54) METHOD OF ADAPTIVE FILTERING OF MULTIPLE SEISMIC REFLECTIONS

(71) Applicant: IFP Energies nouvelles, Rueil-Malmaison Cedex (FR)

(72) Inventors: Laurent DUVAL, NANTERRE (FR); Camille COUPRIE, RUEIL MALMAISON (FR); Jean CHARLETY, RUEIL MALMAISON (FR); Sergi VENTOSA, PUTEAUX (FR); Irène HUARD, ANTONY (FR); Sylvain LE ROY, PALAISEAU (FR); Antonio PICA, VANVES (FR)

(21) Appl. No.: 15/328,820

(22) PCT Filed: Jun. 25, 2015
(86) PCT No.: PCT/EP2015/064455

§ 371 Date: Jan. 24, 2017

(30) Foreign Application Priority Data
Jul. 24, 2014 (FR) 14 57140

(51) Int. Cl. G01V 1/36

(52) U.S. Cl. CPC G01V 1/364

(57) ABSTRACT

The invention is a method for processing seismic data to eliminate the coherent noise arising from multiple seismic reflections. A decomposition procedure is applied to decompose along N directions of decomposition seismic data into a set of N components. At least one model of multiple reflections is decomposed according to the same decomposition procedure and along the same N directions. For each direction of decomposition, a relative concentration between the component of the model of multiples and the component of the data in the direction concerned is calculated. Next a procedure of adaptive filtering of the multiple reflections is applied to each of the seismic components. The filtered seismic components are recombined with the recombination being weighted by a weighting dependent on the relative concentrations calculated for each direction of decomposition.

### CROSS-REFERENCE TO RELATED APPLICATIONS

Reference is made to International Application No. PCT/EP2015/064455 filed Jun. 25, 2015 and French Application No. 14/57.140 filed Jul. 24, 2014, which are hereby incorporated herein by reference in their entirety.

### BACKGROUND OF THE INVENTION

Field of the Invention

The present invention relates to the oil industry and more particularly to the exploration and exploitation of oil reservoirs or of geological gas storage sites.

Description of the Prior Art

A technique widely used in the oil industry in the search for and evaluation of underground reserves is seismic prospecting. Seismic prospecting in general has three steps: the acquisition of seismic data, the processing of these data, and finally the interpretation of the processed data, then called a seismic image.

The step of acquiring the seismic data generally implements the principle of reflection seismics. Reflection seismics consists in emitting a wave or several waves (by explosive or vibration in terrestrial seismics, by air gun or water gun in marine seismics) and item records the signals representing the amplitude variations of the waves that are propagated in the water or the subsoil, and that are at least partially reflected at the level of at least one geological layer boundary (also called an interface) characterized by a seismic impedance contrast. The recording of the waves that are thus reflected is performed by acceleration sensors (seismometers), vibration sensors (geophones) or pressure sensors (hydrophones), or by a combination of elementary sensors of the above types (for example multi-component sensors or OBCs (“Ocean Bottom Cables”)) located at given geographical positions. The signal is recorded typically over a few seconds by a given sensor which is called a seismic trace. The seismic data correspond to a collection of one or more seismic traces, arising from sensors located at various spatial positions, forming a volume in two or three dimensions (one of time, one or two of space), or indeed in four dimensions if repetitive seismic acquisitions are included (acquired in one and the same region at various temporal periods). The distance between a seismic source and a seismic sensor is called the offset. The seismic data recorded in the course of a reflection seismics experiment are termed multi-offset or else pre-summation (known as “prestack”) data, that is to say that the signal emitted by a given source is recorded by several sensors situated at various offsets.

The recorded seismic data, which are called raw data, are quite often unexploitable. Depending on the quality and the characteristics of the recorded data, various seismic processing steps are applied, such as amplitude corrections, deconvolution, static corrections, filtering of (random or coherent) noise, NMO (“Normal Move Out”) correction, stack (“summation”, leading to a zero-offset or post-summation section of the pre-summation seismic data), or else migration. These processing steps, which often requiring often very complex and very lengthy calculations, are carried out by computer. The resulting seismic data are then called a seismic image. These seismic images are usually represented on a computer, by a mesh or grid, with each mesh cell corresponding to a lateral and vertical position (the vertical direction corresponding to the time or to the depth depending on whether the processing has culminated in a time image or a depth image) within the formation being studied, and being characterized by a seismic amplitude. If the seismic processing applied to the recorded seismic data is optimal, the seismic amplitude in a given mesh cell of a seismic image should reflect the amplitude of the seismic wave having undergone a single reflection (called primary reflection) at the position of the mesh cell in the formation being studied.

The seismic images on which the interpretations are conducted by a geologist or else a geophysicist must be sufficiently precise to account for the characteristics of the formation being studied, especially in terms of geometry of the geological layers and faults, but also in terms of seismic amplitudes, which provide information about the petro-physical properties of the formation being studied. Indeed, such information is used to construct representations, called geological models, of the formation being studied, which makes it possible to determine numerous technical parameters relating to the search for, the study of or the exploitation of a reservoir, of hydrocarbons for example.

A particularly tricky step of seismic processing is filtering the noise engendered by coherent parasitic waves, called multiple reflections, which undergo one or more bounces of reflections in the water layer or between at least two geological interfaces. FIG. 1 illustrates the path of a primary reflection P1 arriving at a point A and the path of two multiple reflections M1 and M2 arriving at a point B. The multiple reflections have experienced a part a path in common with the primary reflection P1, but have, in addition, undergone a bounce of reflection between two interfaces bounding a geological layer at the top and at the bottom. First-order multiples are when the seismic wave has undergone a single bounce while second-order multiples are when the seismic wave has undergone two bounces, etc. A multiple reflection arriving at B is recorded with a certain delay relative to the primary reflection arriving at A, corresponding to the propagation time to perform the bouncing between the two interfaces. Depending on the propagation speeds in the layers, it is possible for a multiple reflection recorded at B to interfere with primary reflections associated with deeper seismic reflectors, such as for example with the primary reflection P2 presented in FIG. 1. Through this parasitic interference, the multiple reflections may mask or else falsify the useful information contained in the primary reflections, by modifying the geometry of the primary reflections or else their seismic amplitude.

Before any interpretation of a seismic image is made it is therefore necessary that the recorded seismic data undergo an appropriate processing making it possible to filter, that is to say to eliminate or at least attenuate, the parasitic multiple reflections.

### PRIOR ART

The following documents will be cited in the course of the description:
Nowak, E. J. and Imhof, M. G., Amplitude Preservation of Radon-Based Reflexion Multiple-Removal Filters, Geophysics, 2006, 71, V123-V126.
Chaux, C., Duval, L., Pesquet, J-C., Image Analysis Using a Dual-Tree M-Band Wavelet Transform, IEEE Transactions on Image Processing, August 2006, Volume 15, Issue 8, p. 2397-2412.
Pica, A.; Poulain, G.; David, B.; Magesan, M.; Baldock, S.; Weisser, T.; Hugonnet, P. & Herrmann, P. 3D Surface-Related Multiple Modeling, The Leading Edge, 2005, 24, 292-296.
Ventosa, S., Le Roy, S., Huard, I., Pica, A., Rabeson, H., Ricarte, P., Duval, L., Adaptive Multiple Subtraction with Wavelet-Based Complex Unary Wiener Filters, Geophysics, 2012.

Principally there exist two families of procedures conventionally used to filter the multiple reflections contained in seismic data:

1) A family based on the use of a decomposition procedure (such as the Fourier transform, the Radon transform or else the wavelet transform), is based on the assumption that the seismic data correspond to a summation of components with each component having inherent characteristics (for example a range of particular frequencies, coupled with a particular range of orientations in space). A component is defined by a mathematical function, dependent on the type of decomposition chosen, and by a decomposition coefficient. In the case of the application of a directional wavelet transform aimed at attenuating multiple reflections, the values of the coefficients corresponding to the primary reflections are preserved, while the values of the other coefficients, corresponding to the multiple reflections that are sought to be eliminated, are zeroed or set to a very small value relative to the values of the coefficients corresponding to the primary reflections. An inverse transformation is thereafter implemented so as to recompose the seismic data, which are then at least partially attenuated of the multiple reflections. Such a technique is described for example in Nowak and Imhof (2006).

2) A family based on the use of an adaptive filter of the multiple reflections. This procedure predicts one or more models of multiple reflections, and then subtracts it or them from the seismic data. More precisely, on the basis of one or more models of multiple reflections, this procedure estimates one or more adaptive filters, having a limited number of coefficients. Various procedures for obtaining the filter coefficients are known. Such a technique is for example described in French Patent document FR2994746. A particular mode of application of the adaptive filtering minimizes the square deviation between the seismic data and the model of multiple reflections, by making an assumption of orthogonality between the primary reflections and the multiple reflections.

There does not in general exist any single solution which is satisfactory whatever the seismic data considered. Alternative procedures for filtering the multiple reflections can be obtained by combining the two families of procedures cited above. Such a technique is for example described in the document Ventosa et al. (2012). In contradistinction to the other known procedures, this technique makes it possible to compensate for the defects of the conventional adaptive filtering procedures, which do not best safeguard the frequency content, especially the low and the high frequencies of the seismic data. Thus this procedure filters the data and the models in a frequency band, and then in calculating their inter-correlation coefficient in this frequency band, and finally in subtracting from the original data the product of each model, filtered in the frequency band being considered, times the correlation coefficient obtained. However, the procedure described in Ventosa et al. (2012) does not make it possible to ensure optimal lateral coherence of the filtering of multiples in the presence of significant noise, especially in case of significant dips of the primary reflections or multiple reflections.

Generally, the prior art procedures do not allow optimal filtering of seismic data, that is to say filtering which guarantees complete elimination of multiple reflections, while safeguarding the characteristics of the primary reflections, such as the amplitudes and frequencies. In particular, current seismic acquisition procedures, such as the BroadSeis™ technology developed by CGG (France), making possible acquiring seismic data having a very wide frequency content. It appears to be essential that the filtering of the multiple reflections best guarantees that the frequency content of the recorded seismic data is safeguarded.

### SUMMARY OF THE INVENTION

The present invention is an alternative procedure for filtering the multiple reflections present in seismic data which combines a decomposition procedure and an adaptive filtering procedure, which are followed by a weighted recombining of the filtered components. In particular, the present invention provides better filtering of the multiple reflections, to better preserve the amplitude of the primary reflections, especially when the latter are of low amplitude relative to the multiple reflections and to the random noise.

Thus, the present invention relates to a method for constructing a filtered seismic image of multiple reflections, on a basis of a recording of seismic data comprising primary reflections and multiple reflections and on a basis of at least one model of the multiple reflections. The method comprises at least the following steps:

a) applying a decomposition procedure to decompose, along N directions of decomposition the seismic data into a set of N components of the seismic data;

b) for at least one of the models of the multiple reflections, applying the decomposition procedure to decompose, along the N directions of decomposition, the model of multiple reflections into a set of N components of the model;

c) for each direction of decomposition and for at least one of the models of the multiple reflections, calculating a relative concentration between the component of the seismic data in the direction and the component of the model in the direction;

d) based on at least one of the models of the multiple reflections, applying a procedure for adaptive filtering of the multiple reflections to each of the N components of the seismic data, to obtain a set of N components of the filtered seismic data is obtained; and

e) calculating a weighted recombination of the components of the filtered seismic data, based on a weighting calculated for each direction of decomposition as a function of the relative concentrations calculated in the direction of decomposition.

According to one embodiment of the present invention, the decomposition procedure can be a wavelet transform.

According to a particular embodiment of the present invention, the decomposition procedure can be a dual-tree M-band wavelet transform.

According to one embodiment of the present invention, the adaptive filtering can be a unary Wiener filter using a complex wavelet frame.

According to a preferred mode of implementation of the present invention, the relative concentration between a two-dimensional signal S and a two-dimensional signal S′ can be calculated according to the following formula:

$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$

where s1 is the number of samples in one direction in space and s2 is the number of samples in the other direction in space.

According to one embodiment of the present invention, the weighted recombination can be calculated in the following manner

$$SR = α {\sum }_{n = 1 , N} {ɛ}_{n} , \hat{{D}^{′}} ( 0 , … , {SDF}_{n} , … , 0 )$$

where SDFₙ is the component in the direction n (n=1, N) of the filtered seismic data, α is a constant, εₙ is the weighting for the direction of decomposition n, and \hat{D}′ is an inverse of the decomposition procedure.

According to another embodiment of the present invention, the weighted recombination can be calculated in the following manner:

$$SR = α {\sum }_{n = 1 , N} \hat{{D}^{′}} ( 0 , … , {ɛ}_{n} , {SDF}_{n} , … , 0 )$$

where SDFₙ is the component in the direction n (n=1, N) of the filtered seismic data, α is a constant, εₙ is the weighting for the direction of decomposition n, and \hat{D}′ is an inverse of the decomposition procedure.

According to one embodiment of the present invention in which the inverse of the decomposition procedure is known in an approximate manner, a residual corresponding to the difference between the seismic data and the result of the approximate inverse can be added to the components of the seismic data.

According to a particular mode of implementation of the present invention, the weighting for the direction of decomposition n (n=1, N) can be calculated according to the following formula:

$${ɛ}_{n} = \frac{{\sum }_{i = 1 , I} {ɛ}_{n}^{i}}{I}$$

where εₙⁱ is a weighting for the direction n and the model of multiple reflections i (i=1, I).

According to a particular mode of implementation of the present invention, the weighting for the direction of decomposition n (n=1, N) can be calculated according to the following formula:

$${ɛ}_{n} = {max}_{i = 1 , J} ( {ɛ}_{n}^{i} )$$

where εₙⁱ is a weighting for the direction n and the model of multiple reflections i (i=1, I).

Preferentially, the weighting for the direction of decomposition n and the model of multiple reflections i (with i=1, I and n=1, N) can be calculated according to the following formula:

$${ɛ}_{n}^{i} = W ( x ) , with x = min ( {CR}_{n}^{i} , \frac{1}{{CR}_{n}^{i}} ) ,$$

where W is an increasing function, CRₙⁱ is the relative concentration between the component of the seismic data in the direction n and the component of the model i in the direction n.

Advantageously, the increasing function W can be defined such that for a given x, W(x)=x^{p} with p≧0. Preferentially, it is possible to choose p equal to 4.

It is possible to define a method for exploiting an underground formation by carrying out the following steps:
constructing a filtered seismic image of the multiple reflections by use of a method described above;
constructing a geological model representative of the formation being studied based on at least the seismic image which has been determined;
determining an optimal exploitation scheme for the reservoir based on the basis of the geological model which has been determined; and
exploiting the reservoir by implementing the optimal exploitation scheme.

Furthermore, the invention relates to a computer non transiently recorded program product downloadable from a communication network and/or recorded non transiently on a medium readable by computer and/or executable by a processor, comprising program code instructions for the implementation of the method described above, when the program is executed on a computer.

### BRIEF DESCRIPTION OF THE DRAWINGS

Other characteristics and advantages of the method according to the invention will become apparent on reading the description hereinafter of nonlimiting exemplary embodiments, while referring to the appended figures described hereinafter.

FIG. 1 illustrates a device for acquiring seismic data as well as examples of a trajectory of primary reflections and of multiple reflections generated by this device.

FIGS. 2A and 2B show an example of seismic data before summation and the corresponding model of multiple reflections.

FIG. 3 illustrates a set of different wavelets with each wavelet representing by a particular range of frequencies and a particular range of orientations in space.

FIGS. 4A, 4B, 4C, 4D illustrate the decomposition coefficients for the data presented in FIG. 2A, using 4 different oriented wavelets, which makes possible obtaining preferential directions on four components SD₁, SD₂, SD₃, and SD₄.

FIGS. 4E, 4F, 4G, 4H illustrate the decomposition coefficients for the model of multiples presented in FIG. 2B, using 4 different oriented wavelets, which makes possible obtaining preferential directions on four components MD₁, MD₂, MD₃ and MD₄.

FIG. 5A shows the seismic data already presented in FIG. 2A, before random-noise filtering; FIG. 5B shows the result obtained after applying the procedure described in Ventosa et al. (2012), and FIG. 5C shows the result obtained after applying the method according to the invention.

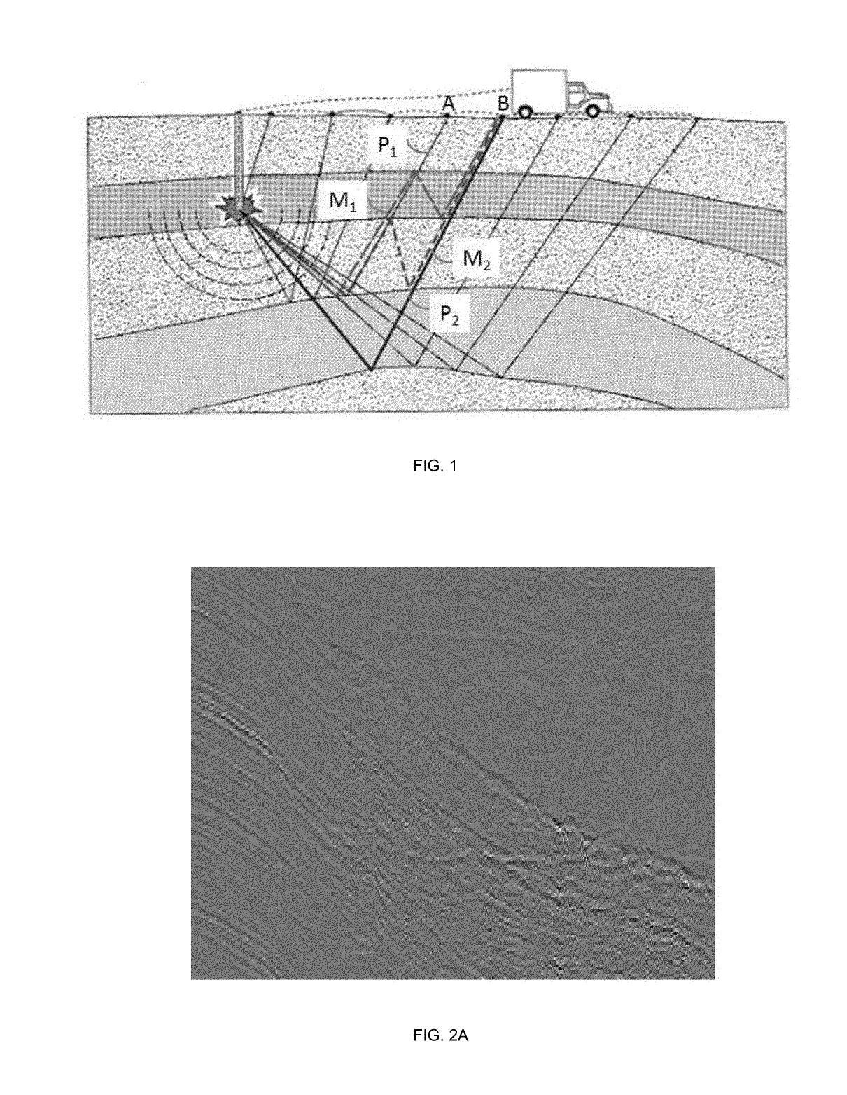

### DETAILED DESCRIPTION OF THE INVENTION

The following definitions are used in the course of the description of the invention:
model of multiples: This model is an approximate model of the multiple reflections contained in seismic data. Several methods for obtaining these models of multiple reflections exist. One method obtains an approximate version of the primary reflection (for example by filtering), and then convolves it with itself or else with the initial seismic trace (see for example Pica et al. (2005)). A model of multiples can also be obtained by solving the wave equation in the medium being considered. In general, models of multiples are satisfactory approximations of multiple reflections. They can however be shifted on the vertical axis (time or depth axis), have amplitudes and/or a frequency spectrum that differ with respect to the actual multiple reflections. Because of this lack of precision, the attenuation processing of the multiple reflections can apply to an adaptation of the models of multiples to the seismic data, by adaptive filtering, also called registration. It should be noted that a model of multiples may have limited relevance, being for example representative of a multiple reflection for a limited range of offsets, or else for a given order of multiples. It is then possible to apply several models of multiples to simulate, completely, a multiple reflection recorded in seismic data.
wavelet decomposition procedure: This procedure makes it possible to decompose seismic data into various components represented by wavelets. A formula for obtaining such wavelets is given hereinafter:

$$g ( x , y ) = exp ( 2 j π \cdot ( {u}_{0} \cdot x + {v}_{0} \cdot y ) + φ ) \times exp ( - ( \frac{{( x - {x}_{0} )}^{2}}{{σ}_{x}} + \frac{{( y - {y}_{0} )}^{2}}{{σ}_{y}} ) )$$

where the coordinates x and y correspond to the position of the sample considered in the seismic data, the pair (u0,v0) defines the coordinates of a vector in a given direction, the norm of this vector defining the frequency, and the terms σₓ and σₓ correspond to the envelope widths in the directions x and y. Each choice of parameters provides a particular directional wavelet. FIG. 3 presents various directional wavelets, each being characterized by an envelope, a main frequency and a particular orientation in space.
energy of a signal: In the case of a two-dimensional signal S characterized by s1 samples in one direction and s2 samples in the other direction, the energy of a signal is defined by the following formula:

$${\sum }_{{s}_{1} , {s}_{2}} {\vert S ( {s}_{1} , {s}_{2} ) \vert}^{2} .$$

The subject of the present invention is a method for constructing a filtered seismic image of the multiple reflections present in seismic recordings, on the basis of one or more models of multiples. This invention uses a decomposition both of the seismic data and of the model of multiples according to preferential directions of decomposition, and a weighted recombining of each of the filtered seismic components according to the corresponding components of the model of multiples. The seismic data may have been recorded by two-dimensional or three-dimensional acquisition devices and be organized according to any type of collection (that is as a common-shot collection, common-receiver collection, etc). The seismic data may correspond equally to pre-summation or post-summation collections, pre-migration or post-migration collections. The present invention may be applied at any stage of the seismic processing, and preferentially before the step of interpreting the seismic image resulting from the application of the seismic processing as a whole. The invention requires that at least one model of multiple reflections be available.

The present invention comprises at least the following steps:

a) applying a decomposition procedure to decompose, along N directions of decomposition, the seismic data into a set of N components of the seismic data;

b) applying for at least one of the models of the multiple reflections, a decomposition procedure to decompose, along the N directions of decomposition, the model of multiple reflections into a set of N components of the model;

c) calculating for each direction of decomposition and for at least one of the models of the multiple reflections, a relative concentration between the component of the seismic data in the direction and the component of the model in the direction;

d) based on at least one of the models of the multiple reflections, applying adaptive filtering of the multiple reflections to each of the N components of the seismic data, to obtain a set of N components of the filtered seismic data;

e) calculating a weighted recombination of the components of the filtered seismic data, based on a weighting calculated for each direction of decomposition as a function of the relative concentrations calculated in the direction of decomposition.

The main steps of the present invention are described hereinafter in the case of two-dimensional post-summation seismic data S, but the method can equally well be applied to three-dimensional seismic data. The main steps of the present invention are specifically described hereinafter in the case of a single model of multiples M. The case of several models of multiples is particularized in a variant of the present invention.

a) Decomposition of the Seismic Data into N Components

This step entails decomposing the seismic data S into N components according to a decomposition procedure \hat{D}. This step better distinguishes certain characteristic features of the seismic data. A series of components SDₙ with n=1, N associated with N different directions of decomposition are thus obtained.

According to one embodiment of the present invention, a decomposition procedure \hat{D} is chosen which makes it possible to decompose seismic data according to various frequency bands and various orientation ranges in space. In this case, a direction of decomposition is a pair made up of a frequency band and an orientation range in space.

According to one embodiment of the present invention, a dual-tree M-band wavelet decomposition procedure, such as described in Chaux et al. (2006), is used. This entails particular directional wavelets, obtained by choosing a set of filters, termed a primal bank of filters with each filter being defined for a specific frequency band, and with the set of filters making it possible to cover a predefined frequency range. Another set of filters, which are deduced from the previous ones and termed a dual bank of filters, is calculated thereafter. This set is obtained by shifting each filter by a half-coefficient by conventional interpolation techniques or by calculation in the Fourier domain. These filters are thereafter applied separately to the horizontal and vertical directions, and combined to provide diagonal directions. In practice, the P frequency bands are defined and the dual bank of filters is constructed as described previously so as to obtain the 4P decompositions according to the various ranges of orientations in space and frequency bands. According to a preferred embodiment of the present, P lies between four and eight. It should be noted that for wavelets of this type, the envelopes are defined by the choice of the frequency ranges and of the orientations in space.

According to one embodiment of the invention, a decomposition procedure is used for which at least one inverse \hat{D}′ is known exactly, that is to say such that \hat{D}′=\hat{D}⁻¹. An inverse of the decomposition procedure, also termed a recombining procedure, makes it possible to recombine the various components SDₙ, with n=1, N, so as to produce the initial seismic data S.

According to one embodiment of the invention, a decomposition procedure is used for which an inverse \hat{D}′ is known in an approximate manner, which is also termed a pseudo-inverse \hat{D}′ or else an approximate recombining procedure. In this case, in order to produce the initial seismic data S, the residual corresponding to the difference between the recorded seismic data S and the result of the chosen pseudo-inverse \hat{D}′ (SDₙ) is added beforehand to the various components SDₙ, with n=1, N.

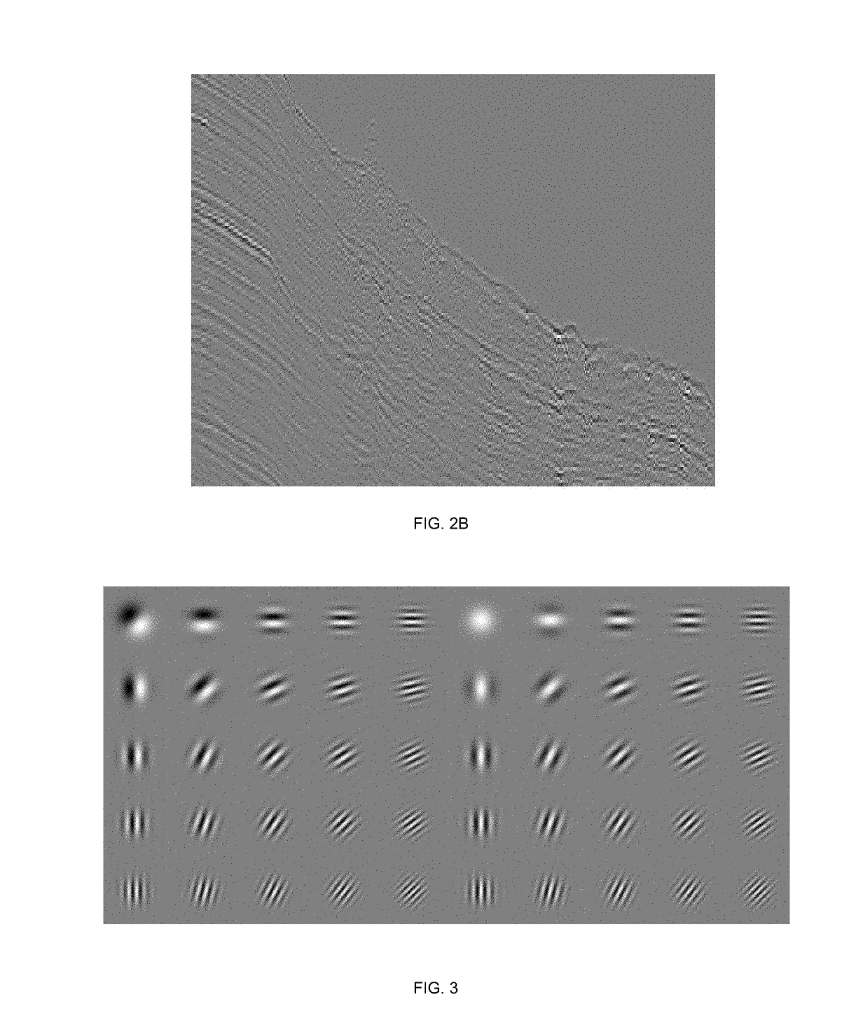

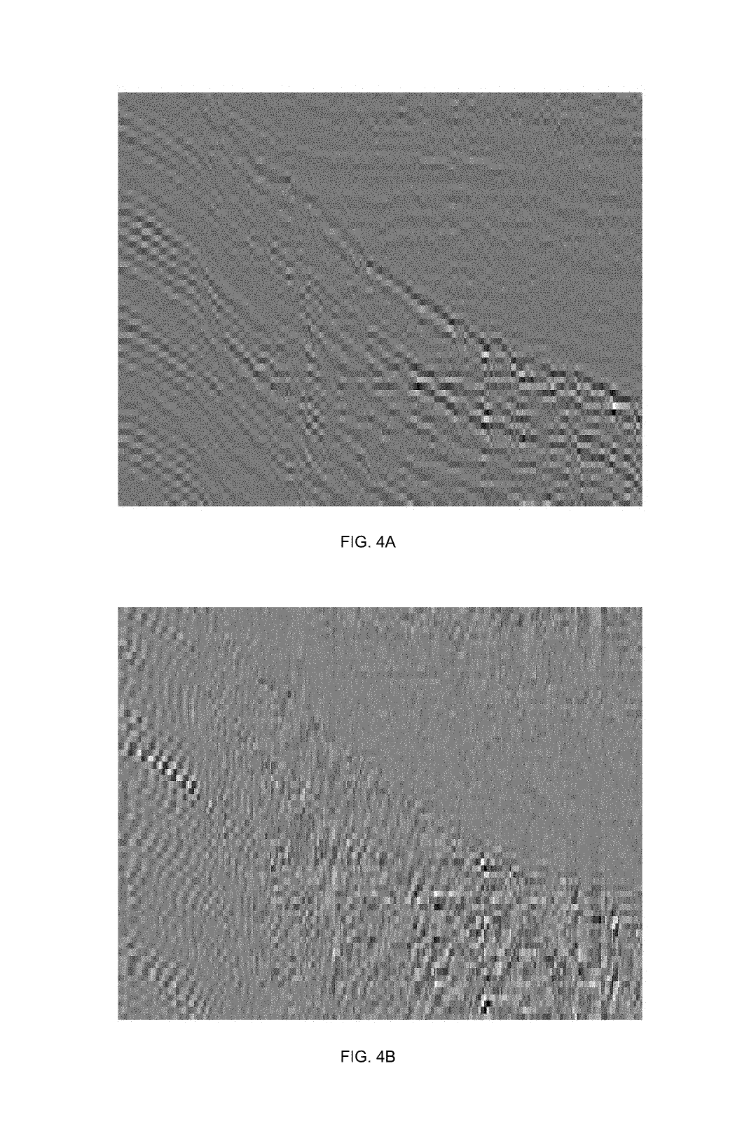

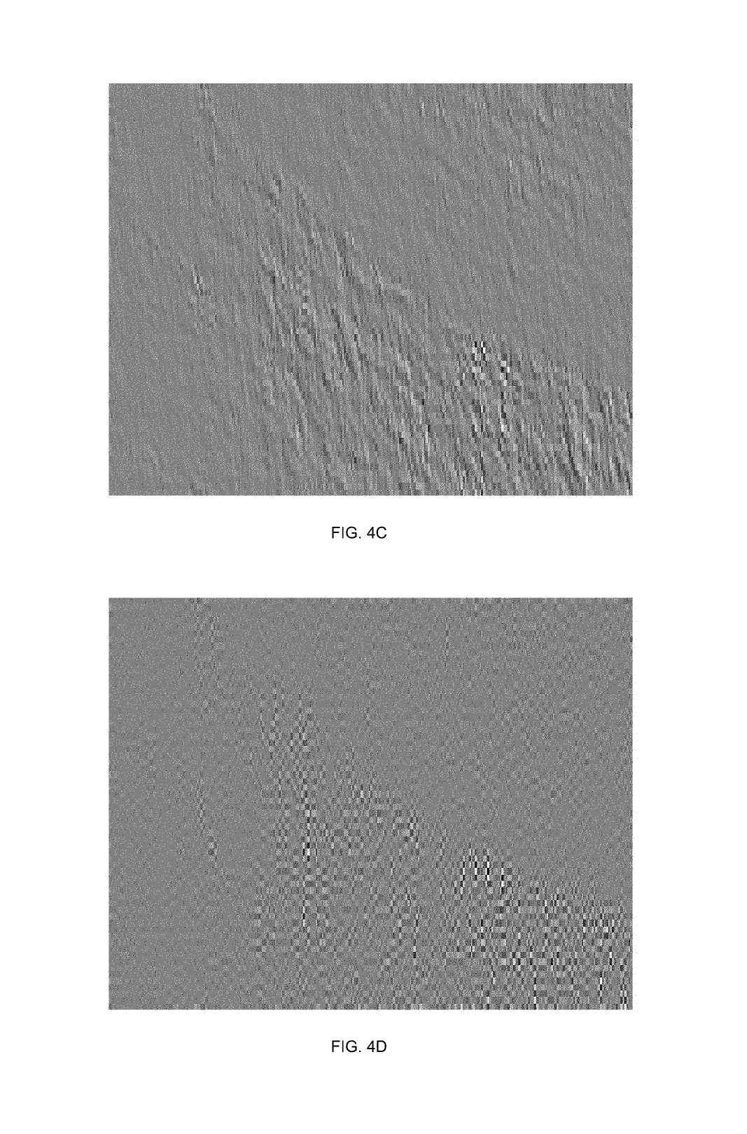

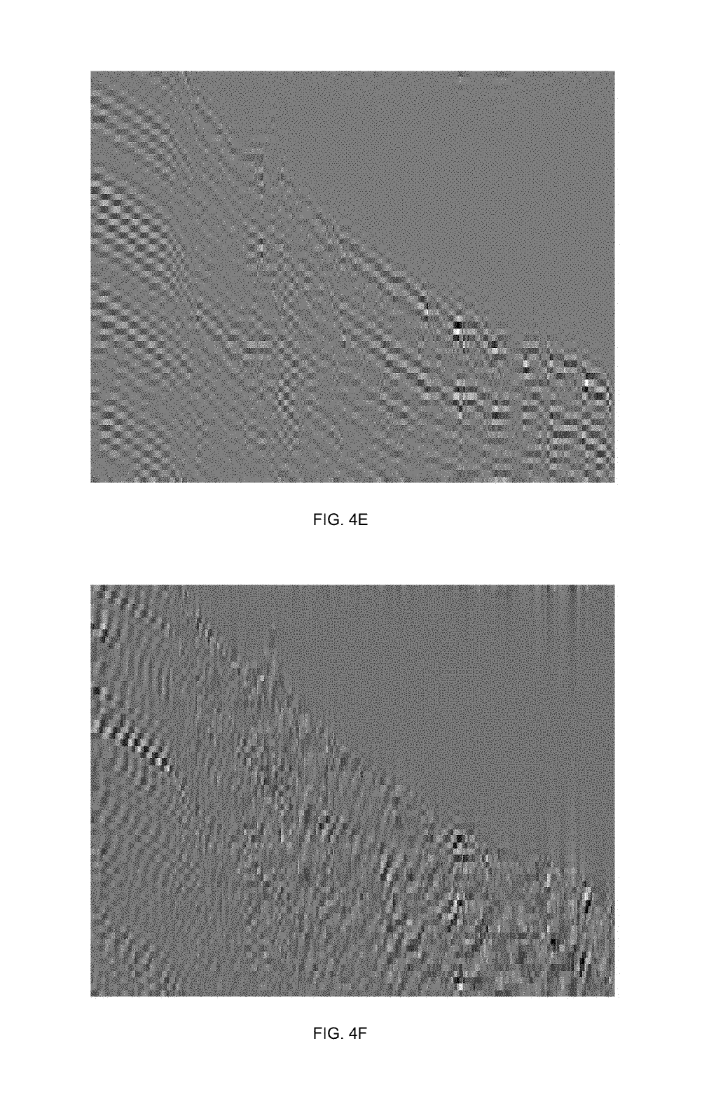

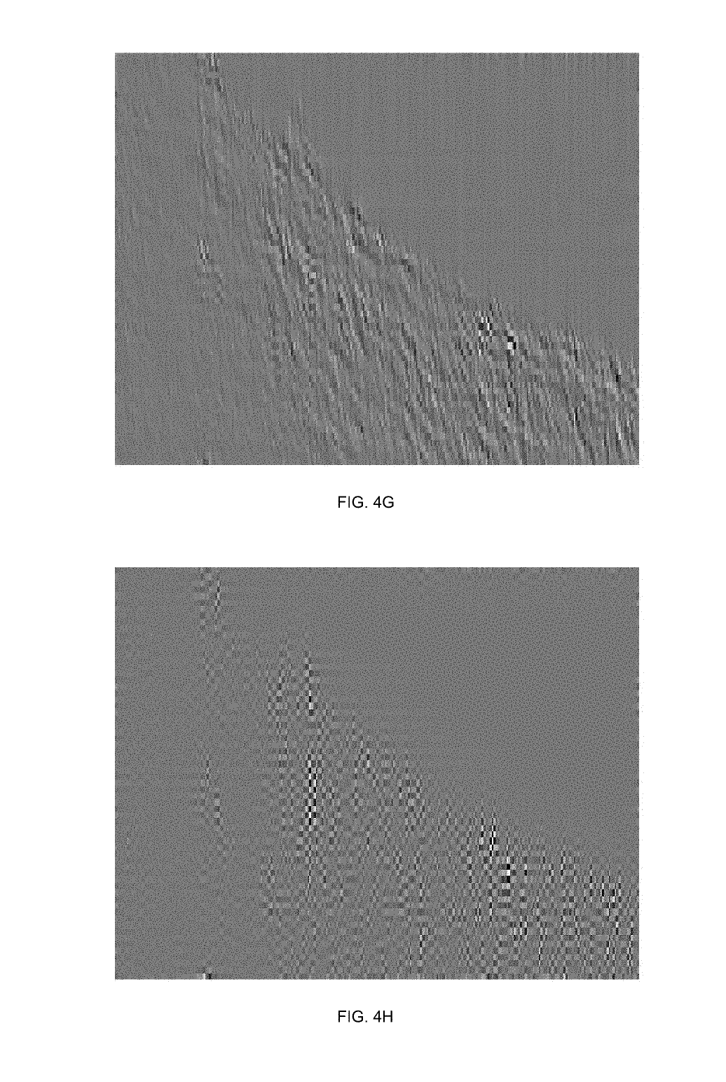

The result of the decomposition procedure described in Chaux et al. (2006), is applied to the seismic data presented in FIG. 2A, which is shown in FIGS. 4A to 4D. Thus, the seismic data S have been decomposed using 4 different directional wavelets, making it possible to obtain four components SD₁, SD₂, SD₃, and SD₄ oriented along 4 different directions in space, which more precisely are a low-frequency isotropic component (FIG. 4A), and three directional components, approximately covering the following angular spans: −23° to +23° (FIG. 4B), 22° to 68° (FIG. 4C), 67° to 113° (FIG. 4D).

b) Decomposition of the Model of Multiples into N Components

This step decomposes the model of multiples M into N components, with the same decomposition procedure \hat{D} and along the same N directions as those defined in step a) of decomposing the seismic data.

A series of components MDₙ with n=1, N is thus obtained.

The result of the decomposition procedure described in Chaux et al. (2006), applied, along the same directions as those used to produce FIGS. 4A to 4D, to the model of multiple reflections presented in FIG. 2B, is shown in FIGS. 4E to 4H. Thus, the model of multiple reflections M has been decomposed into four components MD₁, MD₂, MD₃, and MD₄, oriented along the same directions as those defined to undertake the decomposition of the seismic data.

c) Calculation of the Relative Concentration of the N Components

This step calculates, for each direction of decomposition n (with n=1, N) defined during the previous steps, the relative concentration between the component SDₙ arising from the seismic data in the direction being considered and the component MDₙ arising from the model of multiples in the same direction.

The relative concentration between two signals corresponds to the ratio of the concentration of each of the signals.

According to one embodiment of the invention, the concentration C of a two-dimensional signal S which is defined by s1 samples in one direction and s2 samples in the other direction, is defined in the following manner:

$$C ( S ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - 1}$$

The defined concentration therefore lies between 0 and 1. More precisely, a very concentrated signal, for example such that a single value of this signal is non-zero, has a concentration C equal to 1. On the other hand, a very unconcentrated signal, for example for which all the values of the signal are equal to one another, will have a concentration C equal to 0. The concentration makes it possible in particular to rate the quality of a processing aimed at concentrating the energy of a given signal in an optimal manner. For example, a sinusoidal signal is converted by Fourier transformation into a well-localized frequency spike. Its concentration index is then maximal.

According to one embodiment of the invention, the relative concentration CR between a signal S and a signal S′ which are both two-dimensional and characterized by s1 samples in one direction and s2 samples in the other direction may be then written as:

$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$

The relative concentration CRₙ for a given direction n (with n=1, N) between a component SDₙ arising from the seismic data in this direction n and the component MDₙ arising from the model of multiples in the same direction indicates the capacity of a decomposition procedure to concentrate in an equivalent manner the seismic data and the model of multiples for this direction n. Thus, if the relative concentration CRₙ for a given direction n is greater than 1, the seismic signal is more concentrated than the model of multiples for the direction being considered. And conversely, if the relative concentration is less than 1, then the model of multiples is more concentrated than the seismic signal for this same direction.

d) Adaptive Filtering of the N Seismic Components

This step uses a procedure \hat{F} of adaptive filtering of the primary reflections and the multiple reflections, on the basis of a model of multiples. More precisely, in the course of this step, an adaptive filtering procedure \hat{F} is applied to each of the components SDₙ arising from the seismic data and calculated in step a). Thus, N filtered seismic components SDFₙ of the multiple reflections are obtained in the following manner:

SDFₙ=\hat{F}(SDₙ,MDₙ) with n=1,N.

Thus, the adaptive filtering is not applied to the seismic data themselves but instead to the seismic components arising from the decomposition of the seismic data according to favored frequencies and orientations in space. In this manner, the seismic components are simpler and/or more homogeneous than the original seismic data, the parameters of the adaptive filtering are simpler to estimate, and as a consequence, the adaptive filtering is more efficient. More precisely, the goal of applying an adaptive filter to each component arising from the seismic data is to better eliminate the multiple reflections and to better safeguard the frequency content, component by component.

According to one embodiment of the invention, the adaptive filtering procedure \hat{F} is chosen for its capacity to safeguard the frequency content, and especially the low and high frequencies of the primary reflections.

According to a preferred embodiment of the invention, a procedure for adaptive filtering of multiple reflections by unary Wiener filters using a single-dimensional complex wavelet frame such as described in Ventosa et al. (2012) is used. This procedure makes it possible in fact to best safeguard the frequency content, especially the low and the high frequencies of the seismic data.

e) Weighted Recombining of the N Filtered Seismic Components

The objective of this step is to recombine the N filtered seismic components SDFₙ of the multiple reflections obtained during step d), the recombination being weighted by taking into account the relative concentrations CRₙ (with n=1, N) calculated in step c). Thus, this step recombine the various filtered seismic components, while account for of the efficiency of the decomposition procedure applied to the seismic data and to the model of multiples.

According to one embodiment of the present invention, to carry out the recombination of the various filtered seismic components, recourse is had to an inverse \hat{D}′ of the decomposition procedure \hat{D} such as defined in step a) is used.

According to one embodiment of the present invention, to carry out the recombination of the various filtered seismic components, recourse is had to a pseudo-inverse \hat{D}′, or approximate inverse, of the procedure \hat{D} such as defined in step a).

According to one embodiment of the invention, the concentrated components are favored in equivalent ways, by using a maximum weighting when the relative concentration in the direction considered is close to 1, and a minimum weighting in the converse case.

According to a preferred embodiment of the invention, an increasing function W is considered and a weighting is defined for a given direction n by the value of this function at a point x defined by the minimum between the relative concentration calculated for this direction and its inverse, that is εₙ=W(x) with

$$x = min ( {CR}_{n} , \frac{1}{{CR}_{n}} ) .$$

In this case, the point of evaluation x of the function W necessarily lies between 0 and 1. Moreover, with W being chosen to increase, more significant weight is thus given to the values of x close to 1, that is to say to the equitably concentrated components.

According to one embodiment of the invention, a function is chosen such that for a given value x, W(x)=x^{p} with p≧0.

According to a preferred embodiment of the invention, a function is chosen such that for a given value x, W(x)=x^{p} with p=4.

According to one embodiment of the invention, an estimation SR of the filtered seismic data of the multiple reflections, resulting from the best combinations of the N seismic components SDFₙ filtered by the procedure \hat{F} and complying with the relative concentration of the various components arising from the decomposition procedure \hat{D}, is calculated according to the following formula:

$$x = min ( {CR}_{n} , \frac{1}{{CR}_{n}} ) .$$

where α is a constant. According to one embodiment of the invention, α is chosen so that if zero values are assigned to the model of multiples M, SR is characterized by the same energy as the seismic data S at input. According to a particular embodiment of the invention, α is constant and equal to 1. In this way, the filtered components SDFₙ of the multiple reflections are recombined according to an inverse of the procedure \hat{D}, by zeroing all except one of them, and by assigning the calculated weighting to the recombination of the component in question.

According to another embodiment, an estimation SR of the filtered seismic data of the multiple reflections is calculated in the following manner:

$$SR = α {\sum }_{n = 1 , N} \hat{{D}^{′}} ( 0 , … , {ɛ}_{n} , {SDF}_{n} , … , 0 )$$

where α is a constant. According to one embodiment of the invention, α is chosen in such a way that if zero values are assigned to the model of multiples M, SR is characterized by the same energy as the seismic data S at input. According to a particular embodiment of the invention, α is constant and equal to 1.

In this way, a filtered seismic image of the multiple reflections is obtained, by virtue of an adaptive filtering applied to seismic data decomposed along preferential directions, followed by a recombining of the filtered components taking account of the efficiency of the decomposition procedure.

### Variants

Case of Several Models of Multiples

In the case where several models of multiples M′ with i=1, I are available, the following are repeated for each model:
step b), described hereinbelow, of decomposing the model of multiples: a series of decompositions MDₙ with i=1, I and n=1, N is thus obtained;
step c) of calculating the relative concentration: the relative concentrations CRₙⁱ are thus calculated for each direction n and for each model of multiples i, with i=1, I and n=1, N.

Next, the filtering procedure \hat{F} is applied, for component n (with n=1, N), while accounting for the various models of multiples. More precisely, the N filtered seismic components are calculated in the following manner:

SDFₙ=\hat{F}(SDₙ,MDₙ¹, . . . ,MDₙⁱ, . . . ,MDₙ^{I}) with n=1,N.

Next, the weighting calculation described in step e) of weighted recombining of the filtered seismic components is repeated for each model of multiples. A series of weightings En is thus obtained for all the values of i and of n, with i=1, I and n=1, N.

Next, for each direction n (with n=1, N), a composite weighting εₙ is calculated f based on the set of weightings εₙⁱ (with i=1, I) calculated for each model of multiples.

According to one embodiment of the present invention, a composite weighting εₙ is determined by calculating the average of the individual weightings εₙⁱ i.e.

$${ɛ}_{n} = \frac{{\sum }_{i} {ɛ}_{n}^{i}}{I} .$$

According to a preferred embodiment of the present invention, in order to favor, for a given direction n (with n=1, N), the relative concentration between the seismic data S and at least one of the models of multiples M′, the maximum value among the series of weightings εₙⁱ (with i=1, I) calculated for each model of multiples is allotted to the composite weighting εₙ.

Next, after the calculation of the composite weighting en, an estimation SR of the filtered seismic data of the multiple reflections is calculated by weighted recombination of the filtered seismic components SDFₙ, as described previously in step e).

Exploitation of an Underground Formation

Furthermore, the invention relates to a method for exploiting an underground formation, in which the following steps are carried out:
a filtered seismic image of the multiple reflections is constructed by use of the method as described above;
a geological model representative of the formation being studied is constructed on a basis of at least the determining seismic image;
an optimal exploitation scheme for the reservoir is determined based on the determined geological model and
the reservoir is exploited by implementing the optimal exploitation scheme.

With the help of a geological model constructed based on at least on the information arising from a seismic image obtained during the previous steps, several exploitation schemes can be determined which correspond to various possible configurations of exploitation of the underground reservoir: siting of the producer and/or injector wells, target values for the flowrates per well and/or for the reservoir, the type of tools used, the fluids used, injected and/or recovered, etc. For each of these schemes, it is appropriate to determine their production forecasts. These probabilistic production forecasts can be obtained by use of flow simulation software as well as by use of the fitted numerical model of the reservoir. Reservoir simulation is a technique making it possible to simulate the flows of fluids within a reservoir by means of software called a flow simulator. For example, the PumaFlow® (IFP Énergies nouvelles, France) software is a flow simulator.

One or more possible exploitation schemes suitable for the geological model studied is or are defined. For each of these schemes, the responses are determined by simulation.

On the basis of the probabilistic production forecasts defined for each exploitation scheme, the exploitation scheme can be chosen by comparison which are to them the most relevant. For example:
by comparing the maximum of the oil volume recovered, it is possible to determine the production scheme liable to provide the maximum recovery or to be the most profitable; and
by comparing the standard deviation of the oil volume recovered, it is possible to determine the least risky production scheme.

The reservoir is then exploited according to the exploitation scheme defined for example by drilling new (producer or injector) wells, by modifying the tools used, by modifying the flowrates and/or the nature of fluids injected, etc.

Computer Program Product

The invention relates, moreover, to a computer program product storing a non transient recording downloadable from a communication network and/or recorded on a medium readable by computer and/or executable by a processor. This program comprises program code instructions for the implementation of the method such as described hereinabove, when the program is executed on a computer.

### Examples of Application

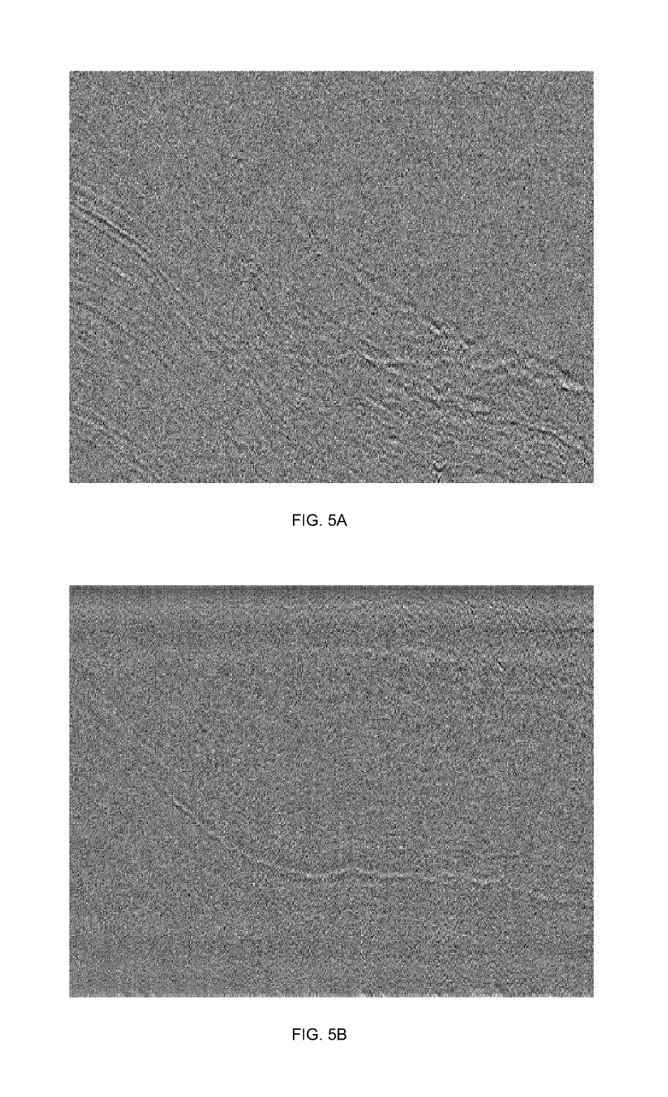

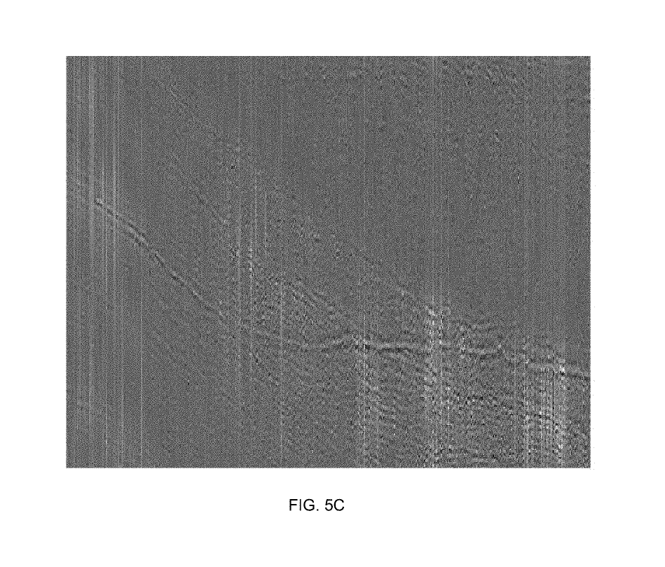

The method according to the invention is applied to a case of two-dimensional real seismic data after summation in the case of the presence of random noise. It is observed in FIG. 5A that the seismic data in question correspond to a superposition of primary seismic reflections and of multiple reflections and the multiple reflections have a very high amplitude relative to the primary reflections. It may also be observed that primary reflections and multiple reflections are strongly disturbed by significant random noise. FIG. 5B presents the result of the application of an adaptive filtering according to the prior art (described in Ventosa et al. (2012)) to the data of FIG. 5A. It is observed that the adaptive filtering according to the prior art correctly reveals the primary reflection of interest in a large part of the zone considered, but that the continuity of this primary reflection is lost in the leftmost part of FIG. 5B. However, this is the part where the reflector that generated the reflection of interest slopes the most. FIG. 5C presents the result of the method according to the invention applied to the seismic data presented in FIG. 5A. The method according to the invention has been implemented by using the technique described in Chaux et al. (2006) for the decomposition procedure and the technique described in Ventosa et al. (2012) for the adaptive filtering. It is very clearly observed that the method according to the invention makes it possible to extract in a sharper manner the primary reflection of interest, in particular in the left part of FIG. 5C. This advantage is in particular obtained through the fact that the method according to the invention applies an adaptive filtering to seismic data decomposed according to favored orientations in space, and that the weighting by the relative concentration strengthens the resemblances between the seismic data and the model of multiples, to the detriment of the undesired noise or disturbances, producing a more precise seismic image of the primary reflections.

Thus, even in the case of seismic data exhibiting strong random noise, the present invention makes it possible to improve the adaptive filtering of multiple reflections contained in seismic data, by operating in a selective manner according to favored frequency bands and ranges of orientations in space.

1-15. (canceled)

16. A method for constructing a filtered seismic image of multiple reflections, based on a recording of seismic data comprising primary reflections and multiple reflections, based on at least one model of the multiple reflections, comprising:
a) applying a decomposition procedure to the seismic data to decompose the seismic data along N directions of decomposition into a set of N components of the seismic data;
b) applying the decomposition procedure to at least one of the models of the multiple reflections to decompose at least one of the models along the N directions of decomposition, into a set of N components of the at least one model;
c) calculating for each direction of decomposition and for at least one of the models of the multiple reflections a relative concentration between the component of the seismic data in each direction and the component of the model in each direction;
d) based on at least one of the models of the multiple reflections, adaptively filtering the multiple reflections is of each of the N components of the seismic data, to obtain a set of N components of the filtered seismic data; and
e) calculating a weighted recombination of the components of the filtered seismic data, based on a weighting calculated for each direction of decomposition as a function of the relative concentrations calculated in each direction of decomposition.

17. The method as claimed in claim 16, wherein the decomposition procedure use a wavelet transform.

18. The method as claimed in claim 16, wherein the decomposition procedure use a dual-tree M-band wavelet transform.

19. The method as claimed in claim 17, wherein the decomposition procedure use a dual-tree M-band wavelet transform.

20. The method as claimed in claim 16, wherein the adaptive filtering comprises a unary Wiener filter using a complex wavelet frame.

21. The method as claimed in claim 17, wherein the adaptive filtering comprises a unary Wiener filter using a complex wavelet frame.

22. The method as claimed in claim 18, wherein the adaptive filtering comprises a unary Wiener filter using a complex wavelet frame.

23. The method as claimed in claim 19, wherein the adaptive filtering comprises a unary Wiener filter using a complex wavelet frame.

24. The method as claimed in claim 16, wherein the relative concentration between a two-dimensional signal S and a two-dimensional signal S′ is calculated according to the following formula:
$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$
where s1 is the number of samples in one direction in space and s2 is the number of samples in the other direction in space.

25. The method as claimed in claim 17, wherein the relative concentration between a two-dimensional signal S and a two-dimensional signal S′ is calculated according to the following formula:
$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$
where s1 is the number of samples in one direction in space and s2 is the number of samples in the other direction in space.

26. The method as claimed in claim 18, wherein the relative concentration between a two-dimensional signal S and a two-dimensional signal S′ is calculated according to the following formula:
$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$
where s1 is the number of samples in one direction in space and s2 is the number of samples in the other direction in space.

27. The method as claimed in claim 20, wherein the relative concentration between a two-dimensional signal S and a two-dimensional signal S′ is calculated according to the following formula:
$$CR ( S ( {s}_{1} , {s}_{2} ) , {S}^{′} ( {s}_{1} , {s}_{2} ) ) = \frac{\sqrt{{s}_{1} {s}_{2}} - \frac{{\sum }_{{s}_{1} , {s}_{2}} \vert S ( {s}_{1} , {s}_{2} ) \vert}{\sqrt{{\sum }_{{s}_{1} , {s}_{2}} {\vert S ( {s}_{1} , {s}_{2} ) \vert}^{2}}}}{\sqrt{{s}_{1} {s}_{2}} - \frac{{\sum }_{{s}_{1} , {s}_{2}} \vert {S}^{′} ( {s}_{1} , {s}_{2} ) \vert}{\sqrt{{\sum }_{{s}_{1} , {s}_{2}} {\vert {S}^{′} ( {s}_{1} , {s}_{2} ) \vert}^{2}}}}$$
where s1 is the number of samples in one direction in space and s2 is the number of samples in the other direction in space.

28. The method as claimed in claim 16, wherein the weighted recombination is calculated as follows:
$$SR = α {\sum }_{n = 1 , N} {ɛ}_{n} . \hat{{D}^{′}} ( 0 , … , {SDF}_{n} , … , 0 )$$
where SDFₙ is the component in the direction n (n=1, N) of the filtered seismic data, α is a constant, εₙ is the weighting for the direction of decomposition n, and \hat{D}′ is an inverse of the decomposition procedure.

29. The method as claimed in claim 17, wherein the weighted recombination is calculated as follows:
$$SR = α {\sum }_{n = 1 , N} {ɛ}_{n} . \hat{{D}^{′}} ( 0 , … , {SDF}_{n} , … , 0 )$$
where SDFₙ is the component in the direction n (n=1, N) of the filtered seismic data, α is a constant, εₙ is the weighting for the direction of decomposition n, and \hat{D}′ is an inverse of the decomposition procedure.

30. The method as claimed in claim 18, wherein the weighted recombination is calculated as follows:
$$SR = α {\sum }_{n = 1 , N} {ɛ}_{n} . \hat{{D}^{′}} ( 0 , … , {SDF}_{n} , … , 0 )$$
where SDFₙ is the component in the direction n (n=1, N) of the filtered seismic data, α is a constant, εₙ is the weighting for the direction of decomposition n, and \hat{D}′ is an inverse of the decomposition procedure.

31. The method as claimed in claim 24, wherein the weighted recombination is calculated as follows:
$$SR = α {\sum }_{n = 1 , N} {ɛ}_{n} . \hat{{D}^{′}} ( 0 , … , {SDF}_{n} , … , 0 )$$
where SDFₙ is the component in the direction n (n=1, N) of the filtered seismic data, α is a constant, εₙ is the weighting for the direction of decomposition n, and \hat{D}′ is an inverse of the decomposition procedure.

32. The method as claimed in claim 16, wherein the weighted recombination is calculated as follows:
$$SR = α {\sum }_{n = 1 , N} \hat{{D}^{′}} ( 0 , … , {ɛ}_{n} , {SDF}_{n} , … , 0 )$$
where SDFₙ, is the component in the direction n (n=1, N) of the filtered seismic data, α is a constant, εₙ is the weighting for the direction of decomposition n, and \hat{D}′ is an inverse of the decomposition procedure.

33. The method as claimed in claim 28, wherein a residual corresponding to a difference between the seismic data and a result of an inverse of a decomposition procedure is added to the components of the seismic data.

34. The method as claimed in claim 28, wherein the weighting for the direction of decomposition n (n=1, N) is calculated as follows:
$${ɛ}_{n} = \frac{{\sum }_{i = 1 , I} {ɛ}_{n}^{i}}{I}$$
where εₙⁱ is a weighting for the direction n and a model of multiple reflections i (i=1, I).

35. The method as claimed in claim 28, wherein the weighting for the direction of decomposition n (n=1, N) is calculated as follows:
$${ɛ}_{n} = {max}_{i = 1 , I} ( {ɛ}_{n}^{i} )$$
where εₙⁱ is a weighting for the direction n and a model of multiple reflections i (i=1, I).

36. The method as claimed in claim 34, wherein the weighting for the direction of decomposition n and the model of multiple reflections i (with i=1, I and n=1, N) is calculated as follows:
$${ɛ}_{n}^{i} = W ( x ) , with x = min ( {CR}_{n}^{i} , \frac{1}{{CR}_{n}^{i}} ) ,$$
where W is an increasing function, CRₙ_{ⁱ} is the relative concentration between the component of the seismic data in the direction n and the component of the model i in the direction n.

37. The method as claimed in claim 36, wherein W is defined such that for a given x, W(x)=x^{p} with p≧0.

38. The method as claimed in claim 34, wherein p equals 4.

39. A method for exploiting an underground formation using a method for constructing a filtered image of multiple reflections based on recording of seismic data comprising primary reflections and multiple reflections based on at least one model of the multiple reflections including
a) applying a decomposition procedure to the seismic data is applied to decompose, along N directions of decomposition, the seismic data into a set of N components of the seismic data; b) applying the decomposition procedure to at least one of the models of the multiple reflections, to decompose, along the N directions of decomposition, at least one of the models of multiple reflections into a set of N components of the at least one model; c) calculating for each direction of decomposition and for at least one of the models of the multiple reflections, a relative concentration between the component of the seismic data in the direction and the component of the model in the direction; d) based on at least one of the models of the multiple reflections, adaptively filtering the multiple reflections is applied to each of the N components of the seismic data, to obtain a set of N components of the filtered seismic data; and e) calculating a weighted recombination of the components of the filtered seismic data, based on the basis of a weighting calculated for each direction of decomposition as a function of the relative concentrations calculated in the direction of decomposition comprising the steps:
constructing a geological model representative of the formation being studied based on at least a determined seismic image;
determining an optimal exploitation scheme for the reservoir is determined based on the determined geological model; and
exploiting the reservoir by implementing the optimal exploitation scheme.
